(19) United States
(12) Patent Application Publication
(10) Pub. No.: US 2015/0366251 A1
(43) Pub. Date: Dec. 24, 2015

(54) Food Additives Containing Glutamic Acid and Nucleotides

(71) Applicant: SYMRISE AG, Holzminden (DE)

(72) Inventors: Christof Fischer, Schongagen (DE); Bernd Keßenich, Hoxter (DE); Oliver Nembach, Beverungen (DE); Simone Peschke, Schorfheide (DE)

(21) Appl. No.: 14/648,361

(22) PCT Filed: Sep. 27, 2013
(86) PCT No.: PCT/EP2013/070197

§ 371 Date: Sep. 8, 2015

(30) Foreign Application Priority Data
Nov. 30, 2012 (EP) 12195062.0

(51) Int. Cl. A23L 1/22; A23L 1/228; A23L 1/229; A23G 1/32

(52) U.S. Cl. CPC A23L 1/22091; A23G 1/32; A23L 1/228; A23L 1/229; A23V 2002/00

(57) ABSTRACT

Food additives are proposed that contain
(a) glutaminic acid and
(b) at least one nucleotide or the alkali metal and/or alkaline earth metal salts thereof
   and also optionally
(c) aroma substances selected from the group formed by purines, polyphenols, 2-acetylpyrazine, 3-methylbutanol, 2-phenylethyl acetate, trimethylpyrazine and also mixtures thereof,
(d) table salt,
(e) sweeteners and/or
(f) acidulants.

### FIELD OF THE INVENTION

The invention relates to the field of foods and relates to novel additives for flavor enhancement and intensification, especially of chocolate and cocoa products.

### Prior art

Umami (Japanese [symbol] ) is the name for one of the basic qualities of the sense of taste, caused, primarily, by glutamates, including, in particular, monosodium glutamate, which is primarily used in Asian cuisine and in the industrial production of convenience foods such as instant soups or prepared foods. The expression taste intensifier, in this context, should be understood as utilizing the physiological taste spectrum present (cf. Yamaguchi, S. et al. Journal of Nutrition. 130:9215-1265 (2000). In this case Umami intensified the intensity of certain flavor directions, but is also able to mask and correct possible taste defects of foods.

EP 2484219 A1 (TableMark Co.) in addition discloses chocolate preparations having an Umami taste, which contain special yeast extracts that have a content of at least 10% by weight of sodium glutamate, at least 1% by weight of sodium inosinate and contain sodium guanylate and also 2-furanmethanol and/or 5-methyl-2-furanmethanol.

The object of the invention was therefore to enhance, intensify and round off the specific taste properties of foods, especially chocolate or cocoa products, by adding an additive having Umami taste quality, and thus significantly improve the sensory perception of the product in subjective evaluation by as many consumers as possible.

### DESCRIPTION OF THE INVENTION

The invention relates to food additives containing
(a) glutamic acid and
(b) at least one nucleotide or the alkali metal and/or alkaline earth metal salts thereof
and also optionally
(c) aroma substances selected from the group formed by purines, polyphenols, 2-acetylpyrazine, 3-methylbutanol, 2-phenylethyl acetate, trimethylpyrazine and also mixtures thereof,
(d) table salt,
(e) sweeteners and/or
(f) acidulants.

Surprisingly, it has been found that mixtures of the said type, even just in small amounts, markedly enhance the pleasant taste of foods, especially of chocolate products. In particular, the Umami perception is significantly intensified.

Nucleotides

Nucleotides are the basic building blocks of the nucleic acids DNA and RNA. Many types of nucleotides have vital regulatory functions in cells, for example ATP, cAMP and GTP. In a nucleotide, the 5′-OH group of the pentose is esterified with one or more phosphate groups. A nucleoside triphosphate, for example adenosine triphosphate (ATP) has three phosphate groups which form acid anhydride bonds among one another. A base is linked to the pentose via the C1′ atom. If the residue R is a hydroxy group, a ribose is present in the case of a hydrogen radical, this is called deoxyribose. Nucleotides are made up of three components:
one phosphoric acid (P) (phosphate),
a monosaccharide (sugar) having five carbon atoms, also termed pentose (Z) which is present as a five ring (furanose ring),
one of five nuclei bases, namely adenine (A), guanine (G), cytosine (C), thymine (T) or uracil (U).

In this case, the sugar is linked to the base via a N-glycosidic bond, and also the phosphate to the sugar via an ester bond; if more than one phosphate is attached, then they are linked to one another via phosphoric anhydride bonds. Preferably, for the purposes of the invention, nucleotides are used which are present as monophosphates, in particular 5′-GMP (E 626)

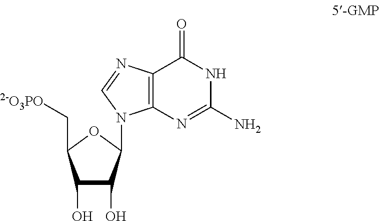

and/or 5-IMP or the sodium (e.g. E 627), potassium (e.g. E 628) or calcium salts (e.g E 629) thereof.

The additives according to the invention can contain the components (a) and (b) in the weight ratio of about 10:90 to about 90:10, preferably about 25:75 to about 75:25, and in particular about 40:60 to about 60:40. The components (a) and (b) can themselves be present in the mixtures in total in amounts of about 1 to about 15, preferably about 2 to about 10, % by weight.

Yeast Extracts

In a preferred embodiment of the invention, the components (a) and (b) can be present in the form of at least one yeast extract. Corresponding products are available on the market, such as, for example, Maxarome Plus powder (DSM), Gistex Hum LS (DSM) or Flav-R-Max (Ohly) contain the components (a) and (b) typically in total in amounts of about 1 to about 15% by weight. Furthermore, the extracts also contain up to 75% by weight proteins and/or free amino acids, such as, e.g., aspartic acid, threonine, serine, glycine, alanine, valine, methionine, isoleucine, leucine, tyrosine, phenylalanine, histidine, lysine, proline or tryptophan and/or the corresponding peptides.

The yeast extracts should additionally be low in sodium chloride, i.e. have a NaCl content of less than about 5% by weight, and in particular less than 2% by weight. In addition, they should be substantially free from glutamate. Substantially in this case it is to be taken to mean that the glutamate content is 0 to a maximum of 1% by weight.

In a further preferred embodiment of the invention, the additives contain
(i) about 20 to about 60% by weight, preferably about 30 to about 50% by weight, of yeast extracts,
(ii) about 10 to about 40% by weight, preferably about 15 to about 30% by weight of table salt,
(iii) about 10 to about 20% by weight, preferably about 12 to 18% by weight of sweeteners, and also
(iv) about 1 to about 10% by weight, preferably about 2 to 8% by weight of acidulants with the proviso that the cited amounts total 100% by weight.

Preferably, these extracts, in addition, contain less than 10% by weight, in particular less than 5% by weight, and particularly preferably less than 0.1% by weight of sodium glutamate. The extracts are, in addition, preferably free from sodium inosinate and sodium guanylate and also 2-furan-methanol and/or 5-methyl-2-furanmethanol.

Aroma Substances

The preparations can contain selected aroma substances, namely, for example,
bitter-tasting purine, in particular theobromine and caffeine,
bitter and astringent-tasting polyphenols, in particular catechins;
substances having roasted notes, such as, e.g., 2-acetylpyrazine;
malt-like tasting substances such as, e.g., 3-methylbutanol;
sweet-tasting substances, such as, e.g., 2-phenylethyl acetate;
and also earthy and roasted-tasting substances, such as, e.g., trimethylpyrazine.

Mixtures of the components (a), (b) and (c) are therefore preferred because the components (a) and (b) not only mask or reduce the adverse taste notes, but also further intensify the desired taste notes. For this purpose, the components can be used in the weight ratio (a+b):(c) in the range from about 5:1 to about 1:5, preferably about 3:1 to about 1:3, and in particular about 2:1 to about 1:2.

As sweeteners, in this context, the following substances and groups of substances come into consideration:
Carbohydrates or sugar, such as, for example sucrose or saccharose, trehalose, lactose, maltose, melizitose, raffinose, palatinose, lactulose, D-fructose, D-glucose, D-galactose, L-rhamnose, D-sorbose, D-mannose, D-tagatose, D-arabinose, D-ribose, D-glyceraldehyde, maltodextrin;
Plant preparations, which predominantly contain the abovementioned carbohydrates, for example based on sugar beet (Beta vulgaris ssp.), sugarcane (Saccharum officinarum ssp.), maple (Acer ssp.), or agaves, and also the processing products thereof (sugar syrup, molasses);
Synthetic or enzymatic hydrolysis products of starches or sucrose (e.g. invert sugar syrup, highly enriched fructose syrup based on wheat starch);
Fruit concentrates, e.g., from apples, pears, grapes, and syrups obtained therefrom;
Sugar alcohols, such as, e.g., erythritol, threitol, arabitol, ribitol, xylitol, sorbitol, mannitol, dulcitol, lactitol;
Proteins, such as, e.g., miraculin, monellin, thaumatin, curculin, brazzein;
Sugar substitutes, such as, e.g., magap, sodium cyclamate, acesulfame K, neohesperidin, dihydrochalcone, saccharin sodium salt, aspartame, superaspartame, neotame, alitame, sucralose, steviosides, rebaudiosides, lugdunam, carrelam, sucrononate, sucrooctate, monatin, phyllodulcin;
Sweet-tasting amino acids, such as, e.g., glycine, D-leucine, D-threonine, D-asparagine, D-phenylalanine, D-tryptophan, L-proline;
Sweet-tasting low-molecular-weight substances, such as, e.g., hernandulcin, dihydrochalcone glycosides, glycyrrhizin, glycyrrhetic acid and esters thereof and
Sweet-tasting extracts, e.g., from liquorice (Glyyrrhizza glabra ssp.), Lippia dulcis, Mormodica ssp., specifically from Mormodica grosvenori (Luo Han Guo) and the corresponding mogrosides, Hydragea dulcis ssp. and Stevia rebaudiana and/or isolates/pure substances therefrom.

Lactic acid or citric acid, for example, can be used as acidulants.

Foods

The present invention further relates to foods which contain the abovementioned additives. These foods are, preferably, but not exclusively, chocolate or cocoa products such as, e.g., milk chocolate, sweet chocolate, semisweet chocolate, also with additives, couverture, ice cream, ice cream coatings, confectionary, chocolates, baked goods, nougat, marzipan, cream fillings, cocoa-containing fat glazings/coating masses and the like. Desserts and dessert powders and also chocolate- or cocoa and caramel-containing drinks and drink powders, such as, e.g., drinking chocolate, milkshakes, liquor products, and the group of the further sugar confectionary are also contained. Particular preference is given to chocolates and boiled sweets.

To achieve a taste-intensifying effect, it is sufficient to add the additives in amounts of about 0.01 to about 1% by weight, and preferably about 0.05 to about 0.15% by weight.

### INDUSTRIAL APPLICABILITY

The present invention further relates to a method for intensifying the rounded and Umami taste of chocolate or cocoa products which is distinguished in that an amount of 0.01 to 1% by weight of a mixture containing
(a) glutaminic acid and
(b) at least one nucleotide or the alkali metal and/or alkaline earth metal salts thereof
   and also optionally
(c) aroma substances selected from the group formed by purines, polyphenols, 2-acetylpyrazine, 3-methylbutanol, 2-phenylethyl acetate, trimethylpyrazine and also mixtures thereof,
(d) table salt,
(e) sweeteners and/or
(f) acidulants
   is added thereto.

The invention finally relates to the use of mixtures containing
(a) glutamic acid and
(b) at least one nucleotide or the alkali metal and/or alkaline earth metal salts thereof
   and also optionally
(c) aroma substances selected from the group formed by purines, polyphenols, 2-acetylpyrazine, 3-methylbutanol, 2-phenylethyl acetate, trimethylpyrazine and also mixtures thereof,
(d) table salt,
(e) sweeteners and/or
(f) acidulants
   as taste-intensifying additives to chocolate or cocoa products. The additives intensify, in particular, the Umami perception during consumption, and are added to the chocolate or cocoa products in amounts of about 0.01 to about 1% by weight, and preferably about 0.05 to about 0.15% by weight.

### EXAMPLES

### Example 1, Comparative Example C1

The following study is based on the taste evaluations of a test group of 81 people. The testers were sought with respect to their preference for chocolate and chocolate products, such as, for example, chocolate ice cream or ice cream with chocolate coating. 65% of the participants were female, the rest male. The age of the testers was between 16 and 65 years. Each of the testers was presented with a commercially conventional milk chocolate preparation once without and once with addition of 0.04% by weight of an additive mixture according to the invention for taste evaluation.

The additive was a preparation consisting of 45% by weight of a mixture of three different commercially conventional yeast extracts, 34% by weight of table salt, 16% by weight of sugar or sucrose, and also 5% by weight of lactic acid.

The assessment was performed on a scale from 1 (=unacceptable in taste) to 9 (=excellent). The results are summarized in the following table 1:

TABLE 1
Taste assessment milk chocolate/preference test

| | Taste scale (assessments in % based on the tester panel) | | | | | | | | |
|---|---|---|---|---|---|---|---|---|---|
| Example | 1 | 2 | 3 | 4 | 5 | 6 | 7 | 8 | 9 |
| C1 | 0 | 5 | 1 | 10 | 6 | 19 | 40 | 15 | 5 |
| 1 | 0 | 1 | 2 | 2 | 6 | 28 | 28 | 28 | 2 |

The mean value of the assessments shifts from 6.3 to 6.7 in favor of the product according to the invention. In particular, however, the fraction of particularly positive assessments (6 to 9) increased from 78 to 88%, and here the fraction of assessments having the scores 8 and 9 from 20 to 31%. The results of the preference test therefore show significant taste enhancement when the additives according to the invention are used.

1. A food additive containing
(a) glutamic acid, and
(b) at least one nucleotide or the alkali metal and/or alkaline earth metal salts thereof,
and optionally
(c) an aroma substance selected from the group consisting of purines, polyphenols, 2-acetylpyrazine, 3-methylbutanol, 2-phenylethyl acetate, trimethylpyrazine and mixtures thereof,
(d) table salt,
(e) sweetener, and/or
(f) acidulant.

2. The additive as claimed in claim 1, wherein the at least one nucleotide contains one or more bases selected from the group consisting of adenine, guanine, cytosine, thymine and uracil and mixtures thereof.

3. The additive as claimed in claim 1 containing monophosphates as component (b).

4. The additive as claimed in claim 1, containing 5′-GMP and/or 5-TMP and/or the sodium, potassium or calcium salts thereof, as component (b).

5. The additive as claimed in claim 1, containing components (a) and (b) in the weight ratio of about 10:90 to about 90:10.

6. The additive as claimed in claim 1, containing components (a) and (b) in total in amounts of about 1 to about 15% by weight.

7. The additive as claimed in claim 1, containing components (a) and (b) in the form of at least one yeast extract.

8. The additive as claimed in claim 7, wherein the yeast extract contains components (a) and (b) in total in amounts of about 1 to about 15% by weight.

9. The additive as claimed in claim 7, wherein the yeast extract has sodium chloride content of less than about 5% by weight.

10. The additive as claimed in claim 7, containing
(i) about 20 to about 60% by weight of yeast extract,
(ii) about 10 to about 40% by weight of table salt,
(iii) about 20 to about 30% by weight of sweetener, and
(iv) about 1 to about 10% by weight of a acidulant,
with the proviso the amounts total 100% by weight.

11. A food containing the additive as claimed in claim 1.

12. The food as claimed in claim 11, which is a chocolate product or boiled sweet.

13. The food as claimed in claim 11, wherein the additive is additive present in amounts of about 0.01 to about 1% by weight.

14. A method for intensifying the Umami taste of a chocolate or cocoa product, comprising the step of adding to the chocolate or cocoa product, an amount of 0.01 to 1% by weight of a mixture containing
(a) glutaminic acid, and
(b) at least one nucleotide or the alkali metal and/or alkaline earth metal salts thereof,
and optionally
(c) an aroma substance selected from the group formed by purines, polyphenols 2-acetylpyrazine, 3-methylbutanol, 2-phenylethyl acetate, trimethylpyrazine and mixtures thereof,
(d) table salt,
(e) sweetener, and/or
(f) acidulant.

15. A method of intensifying taste of a chocolate or cocoa product comprising the step of adding to the chocolate or cocoa product, a mixture containing
(a) glutaminic acid, and
(b) at least one nucleotide or the alkali metal and/or alkaline earth metal salts thereof,
and optionally
(c) an aroma substance selected from the group formed by purines, polyphenols, 2-acetylpyrazine, 3-methylbutanol, 2-phenylethyl acetate, trimethylpyrazine and mixtures thereof,
(d) table salt,
(e) sweeteners sweetener, and/or
(f) acidulant,
as taste-intensifying additives.
